(19) United States
(12) Patent Application Publication
(10) Pub. No.: US 2009/0074957 A1
(43) Pub. Date: Mar. 19, 2009

(54) Electrode for electrochemical cell and electrochemical cell including the electrode

(76) Inventors: Jin-hwan Park, Jung-gu (KR); Mi-jeong Song, Suwon-si (KR); Dong-min Im, Seocho-gu (KR)

Correspondence Address: CHRISTIE, PARKER & HALE, LLP, PO BOX 7068, PASADENA, CA, 91109-7068, US

(21) Appl. No.: 12/291,200

(22) Filed: Nov. 7, 2008

Related U.S. Application Data
(62) Division of application No. 11/329,594, filed on Jan. 10, 2006, now abandoned.

(30) Foreign Application Priority Data
Jan. 11, 2005 (KR) 10-2005-0002449

(51) Int. Cl. B05D 5/12

(52) U.S. Cl. 427/115

(57) ABSTRACT

An electrode for an electrochemical cell is provided. The electrode comprises an electrode active material coated on a current collector. The surface of the electrode active material has a greater porosity than the portion nearest the current collector. The electrode includes an active material with controlled porosity, where the porosity of the inner portion is equal to or less than the porosity of the surface of the electrode after the electrode is roll-pressed. As a result, the impregnating characteristics of the electrolytic solution are improved and decreases in capacity upon charging and discharging at high rates are prevented. Therefore, excellent charge and discharge characteristics are obtained. In addition, cells including the inventive electrodes exhibit excellent charge and discharge characteristics.

### CROSS-REFERENCE TO RELATED PATENT APPLICATIONS

This application is a divisional application of U.S. patent application Ser. No. 11/329,594, filed on Jan. 10, 2006, which claims priority to and the benefit of Korean Patent Application No. 10-2005-0002449, filed on Jan. 11, 2005, in the Korean Intellectual Property Office, the entire content of which is incorporated herein by reference.

### FIELD OF THE INVENTION

The present invention relates to an electrode having controlled porosity for an electrochemical cell, and to an electrochemical cell having the same. More particularly, the invention is directed to an electrode in which non-uniform porosity of the electrode active material, which occurs during roll-pressing, is prevented, thereby improving the charge and discharge characteristics of the electrochemical cell including the electrode.

### BACKGROUND OF THE INVENTION

Electrochemical cells, e.g. secondary batteries, are used in portable electronic devices, and the demand for these electrochemical cell has been increasing. As portable devices become smaller and lighter in weight, they require high performance and electrochemical cells having high capacity are required. In order to obtain an electrochemical cell with high capacity, an electrode material having high capacity can be used, or the density of the electrode can be increased using physical methods.

When an electrode material having high capacity is used, the electrode material can be a metal, such as lithium or the like. However, when lithium or the like is repeatedly charged and discharged, lithium dendrite grows on the surface of the electrode, short-circuiting the electrode. As such, use of a metal decreases stability. On the other hand, use of a carbon material is safe because no side reactions occur and a variety of carbon material powders can be made. However, the use of carbon material results in low electrical capacity. Therefore, to increase the electrical capacity, the electrode can be roll-pressed or the like to increase density.

However, when the electrode is roll-pressed or the like, electrode density increases, but porosity decreases due to a decrease in volume, thus decreasing the impregnating characteristics of the electrolytic solution. If this happens, the electrolytic solution cannot sufficiently penetrate the inner portion of the electrode, thereby decreasing the contact area between the electrode and the electrolytic solution. Accordingly, ions are not sufficiently transported to the electrode and sufficient cell capacity cannot be obtained. Further, when the cell is charged and discharged at a high rate, cell performance decreases.

Many techniques have been developed to improve the impregnating characteristics of the electrolytic solution. For example, in Japanese Laid-open Patent No. 1994-060877, the impregnating characteristics are improved by treating the anode with plasma, or by adsorbing a wetting agent onto the anode. When plasma-treated, the surface of the anode becomes rough. When the wetting agent is adsorbed into the anode, interfacial tension between the electrode and electrolytic solution decreases.

In Japanese Laid-open Patent No. 1996-162155, the impregnating characteristics of the electrolytic solution are improved by adding a non-ionic surfactant to the electrolytic solution. In this technique, the non-ionic surfactant acts as the wetting agent and is directly added not into the electrode but into the electrolytic solution.

When an electrode operates, its temperature increases and the electrode active material expands, thereby decreasing the amount of the electrolytic solution which eventually becomes insufficient. In Japanese Laid-open Patent No. 1999-086849, an electrode having a high-temperature electrolytic solution and a conductive material is used to prevent insufficiency of the electrolytic solution.

These conventional techniques, in which the surface of the electrode is modified or the temperature changed, are effective. However, when the porosity of the electrode active material is decreased from roll-pressing or the like, and the contact surface between the electrode and electrolytic solution decreases, it becomes very difficult to improve impregnating characteristics.

In particular, when the electrode is roll-pressed, the pressure applied is greatest at the surface of the electrode such that porosity decreases and density increases from the inner portion to the surface of the electrode. Accordingly, even when the inner portion of the electrode is sufficiently porous, the surface of the electrode is less porous and the electrolytic solution cannot sufficiently penetrate the inner portion of the electrode. As a result, a method of manufacturing an electrode with sufficient porosity is required.

### SUMMARY OF THE INVENTION

In one embodiment, the present invention is directed to an electrode with controlled porosity for an electrochemical cell, and to an electrochemical cell having the electrode. In another embodiment, the present invention is directed to a method of manufacturing the electrode.

According to an embodiment of the present invention, an electrode for an electrochemical cell comprises an electrode active material coated on a current collector, wherein the porosity of the electrode active material near the exposed surface is greater than the porosity of the electrode active material nearest the current collector.

In one embodiment, the porosity is greatest at the surface of the electrode active material contacting the electrolytic solution.

In another embodiment, the porosity increases as the time of contact between the electrode active material and the electrolytic solution increases. The electrode active material may be a sinter of an active material and a pore forming material.

According to another embodiment of the present invention, an electrochemical cell includes the electrode.

According to yet another embodiment of the present invention, a method of forming an electrode for an electrochemical cell comprises coating a current collector with an electrode active material, coating the coated current collector with a mixture of a pore forming material and the electrode active material to form an electrode, roll-pressing the electrode, and sintering the roll-pressed electrode.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become more apparent by reference to the following detailed description when considered in conjunction with the attached drawings in which:

FIG. 1 is an energy dispersive X-ray spectroscopy (EDS) image of a cross section of a roll-pressed cobalt oxide electrode according to the prior art;

FIG. 2 is a scanning electron microscopy (SEM) image of a carbon anode according to one embodiment of the present invention in which the carbon anode is coated with a pore forming material and roll-pressed; and

FIG. 3 is an SEM image of the carbon anode of FIG. 2 after removal of the pore forming material.

### DETAILED DESCRIPTION OF THE INVENTION

An electrode for an electrochemical cell according to one embodiment of the present invention includes an electrode active material having constant porosity which can retain that porosity after roll-pressing. Such an electrode imparts improved charge and discharge characteristics. In conventional electrodes, porosity substantially decreases near the surface of the electrode when roll-pressed, adversely affecting the impregnating characteristics of the electrolytic solution.

An electrode is roll-pressed to decrease its volume and to increase its energy density. Upon roll-pressing, the thickness of the active material layer coated on the current collector decreases to about half the original thickness or less. The greatest pressure is applied to the portion of the active material located farthest from the current collector, thereby imparting the greatest density and least porosity to the portion of the electrode material located farthest from the current collector.

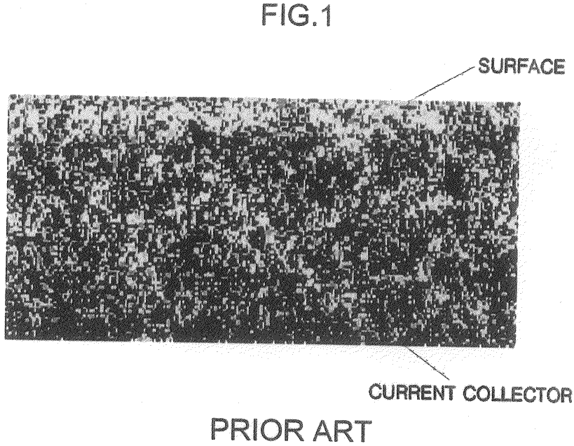

FIG. 1 is an energy dispersive X-ray spectroscopy (EDS) image of a cross section of a prior art electrode formed by coating a current collector with a mixture of cobalt oxide, a conducting agent and a binder, and roll-pressing the resulting electrode. The cobalt oxide is used as the cathode active material. In FIG. 1, the yellow portions represent the cobalt oxide used as the active material. As can be seen, the density of the active material gradually increases from the current collector to the surface, indicating a gradual decrease in porosity. As seen in FIG. 1, the porosity is greatest nearest the current collector and the porosity is least nearest the surface, which is common in roll-pressed electrodes.

However, according to one embodiment of the present invention, an electrode for an electrochemical cell has a porosity near its surface equal to or greater than the porosity nearest the current collector. According to this embodiment, the electrode has a different porosity pattern that conventional electrodes, in which porosity near the surface is less than the porosity near the current collector. When the porosity near the surface is greater than the porosity near the current collector, the impregnating characteristics of the surface (where the electrolytic solution first contacts the electrode) are improved, enabling the electrolytic solution to easily penetrate the inner portion of the electrode.

The electrode can be used in any type of electrochemical cell. For example, it can be used as a cathode or anode of a lithium battery. In particular, it can be used as a carbon anode. Metal material can easily be impregnated with the electrolytic solution, but the carbon material has relatively bad impregnating characteristics. Specifically, when the density of the carbon material increases during roll-pressing or the like, the impregnating characteristics become very poor. A nonlimiting example of a suitable carbon material is graphite, or the like.

The porosity of the electrode active material may be greatest at the surface contacting the electrolytic solution. In conventional roll-pressed electrodes, the porosity of the active material may be least where contacting the electrolytic solution, thus preventing electrons or ions from moving to the electrode active material near the current collector via the electrolytic solution. This substantially decreases the contact area between the electrode and the electrolytic solution. As a result, cell performance decreases. When the porosity near the surface contacting the electrolytic solution is increased, this problem is overcome and the impregnating characteristics of the electrode are improved.

The porosity of the electrode active material may increase as contact time between the electrode active material and the electrolytic solution increases. The electrode active material may further include a pore forming material that can be dissolved in the electrolytic solution. After the cell is formed and the electrode contacts the electrolytic solution, the pore forming material begins to dissolve in the electrolytic solution and generates pores, thereby increasing the porosity at the surface of the electrode.

The electrode active material may be formed by sintering the active material with the pore forming material. The pore forming material included in the roll-pressed electrode active material thermally decomposes by sintering such that pores are produced and non-uniform density resulting from the roll-pressing is prevented. The size of the pores formed by sintering, and the porosity, can be controlled by selecting the particle size, distribution and the like of the pore forming material.

Any material capable of producing pores can be used as the pore forming material. Nonlimiting examples of suitable materials for the pore forming material include thermally decomposable materials, materials capable of dissolving in the electrolytic solution and mixtures thereof.

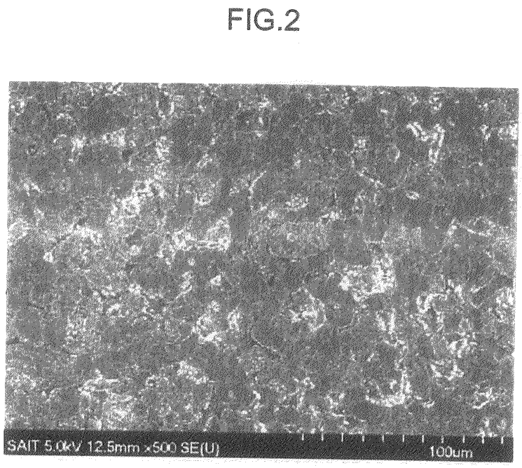

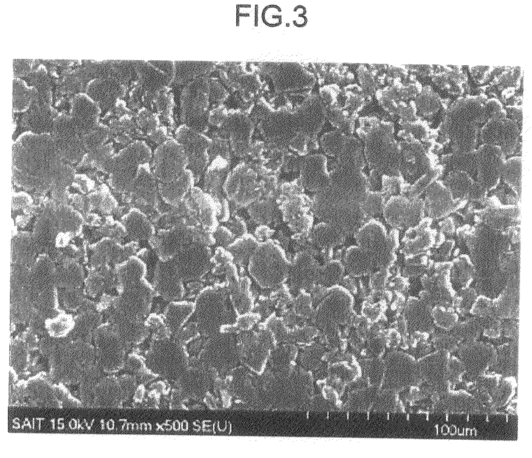

FIG. 2 is a scanning electron microscopy (SEM) image of an electrode according to one embodiment of the present invention in which the electrode is further coated with the pore forming material and then roll-pressed. When the electrode is sintered at a predetermined temperature, the pore forming material decomposes and porosity increases. FIG. 3 is an SEM image of the surface of the electrode after sintering. As can be seen, the porosity of the electrode in FIG. 3 is greater than that of the electrode in FIG. 2.

When the pore forming material is a thermally decomposable material, it is vaporized by heat, leaving pores. When the pore forming material is not decomposable by heat, it generates pores after contacting the electrolytic solution. When the pore forming material is a mixture of thermally decomposable materials and materials capable of dissolving in the electrolytic solution, some of the pore forming material thermally decomposes by heat to form pores which the electrolytic solution penetrates, and the remaining pore forming material dissolves in the penetrated electrolytic solution, thereby producing pores.

Nonlimiting examples of suitable thermally decomposable materials include ammonium carbonate, ammonium bicarbonate, ammonium oxalate, and the like. Nonlimiting examples of suitable materials capable of dissolving in the electrolytic solution include salts that can easily dissolve in non-aqueous electrolytes, such as lithium salt or the like. Nonlimiting examples of suitable lithium salts include LiClO₄, LiBF₄, LiPF₆, LiCF₃SO₃, and the like.

The amount of the pore forming material in the electrode ranges from about 0.1 to 10% by weight based on the total weight of the electrode active material. When the amount of the pore forming material is greater than about 10% by weight, the density of the electrode decreases. When the amount of the pore forming material is less than about 0.1% by weight, controlled porosity is difficult to achieve.

An electrochemical cell according to one embodiment of the present invention includes the above-described electrode for an electrochemical cell. The electrochemical cell may be a lithium battery, but is not limited thereto.

One method of manufacturing the lithium battery will now be described. However, it is understood that other methods may be used to manufacture the lithium battery.

First, a cathode active material composition is formed by mixing a cathode active material, a conducting agent, a binder, and a solvent. The cathode active material composition is coated directly on a metal current collector and dried, thereby forming a cathode plate. Alternatively, the cathode active material composition is cast onto a separate support, peeled, and then laminated on the metal current collector, thereby forming the cathode plate.

The cathode active material may be any lithium-containing metal oxide commonly used in the art. Nonlimiting examples of suitable cathode active materials include LiCoO₂, LiMnₓO₂ₓ, LiNi₁₋ₓMnₓO₂ₓ(x=1, 2), Ni_{1-x-y}CoₓMn_{y}O₂ where 0≦x≦0.5, 0≦y≦0.5, and the like. Specifically, the cathode active material may be a compound in which lithium can be oxidized and reduced, such as LiMn₂O₄, LiCoO₂, LiNiO₂, LiFeO₂, V₂O₅, TiS, MoS, or the like.

One nonlimiting example of a suitable conducting agent is carbon black.

Nonlimiting examples of suitable binders include vinylidene fluoride/hexafluoropropylene copolymers, polyvinylidenefluoride, polyacrylonitrile, polymethylmethacrylate, polytetrafluoroethylene, styrene butadiene rubber polymers, and mixtures thereof.

Nonlimiting examples of suitable solvents include N-methylpyrrolidone, acetone, water, and the like.

The amounts of cathode active material, conducting agent, binder, and solvent are the same as in conventional lithium batteries.

The lithium battery further comprises a separator, which can be any separator commonly used in lithium batteries. One exemplary separator has low resistance to the movement of the ions of the electrolytic solution and good electrolytic solution binding capacity. Nonlimiting examples of suitable materials for the separator include glass fiber, polyester, Teflon, polyethylene, polypropylene, polytetrafluoroethylene (PTFE), and mixtures thereof in the form of woven or non-woven fabrics. In lithium ion batteries, polyethylene, polypropylene or the like is used as the separator, and is capable of being wound. In lithium ion polymer batteries, separators with good impregnating capacity for organic electrolytic solutions are used.

One exemplary method of manufacturing the separator will now be described. However, it is understood that other methods can also be used. First, a separator composition is produced by mixing a polymer resin, a filling agent, and a solvent. The separator composition is directly coated on a surface of an electrode, thereby forming a separator film. Alternatively, the separator composition is cast onto a support, dried, peeled, and laminated on a surface of the electrode.

The polymer resin can be any material capable of bonding to an electrode plate. Nonlimiting examples of suitable polymer resins include vinylidenefluoride/hexafluoropropylene copolymers, polyvinylidenefluoride, polyacrylonitrile, polymethylmethacrylate, and mixtures thereof. The electrolytic solution may contain a compound selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) where each of x and y is a natural number, LiCl, Lil, and mixtures thereof. This compound is dissolved in a solvent selected from the group consisting of propylene carbonate, ethylene carbonate, diethyl carbonate, ethyl methyl carbonate, methyl propyl carbonate, butylene carbonate, benzonitrile, acetonitrile, tetrahydrofuran, 2-methyltetrahydrofuran, γ-butyrolactone, dioxolane, 4-methyldioxorane, N,N-dimethylformamide, dimethylacetamide, dimethylsulfoxide, dioxane, 1,2-dimethoxyethane, sulforane, dichloroethane, chlorobenzene, nitrobenzene, dimethylcarbonate, methylethylcarbonate, diethylcarbonate, methylpropylcarbonate, methylisopropylcarbonate, ethylpropylcarbonate, dipropylcarbonate, dibutylcarbonate, diethyleneglycol, and mixtures thereof.

The separator is positioned between the cathode plate and the anode plate, thus forming a cell structure. The cell structure is wound or folded and then sealed in a cylindrical or rectangular battery case. The organic electrolytic solution is then injected into the battery case to complete the lithium ion battery.

The cell structures can be stacked to form a bi-cell structure, which is impregnated with the organic electrolytic solution. The resulting cell is sealed in a pouch to form a lithium ion polymer battery.

A method of manufacturing an electrode for an electrochemical cell according to one embodiment of the present invention will now be described. However, it is understood that other methods can be used.

First, an electrode active material is coated on a current collector. Then, a mixture of a pore forming material and an electrode active material is coated on the resulting current collector, thereby forming an electrode. The electrode is then roll-pressed and sintered to form an electrode for an electrochemical cell.

Alternatively, an electrode active material is coated on a current collector and a pore forming material is coated on the active material. The dual coated electrode is then roll-pressed and sintered, thereby forming an electrode for an electrochemical cell.

The inventive electrodes can be used in any type of electrochemical cell for example, they can be cathodes or anodes of lithium batteries. In one embodiment, the electrode is a carbon anode. Metal material can be easily impregnated with the electrolytic solution, while carbon material has relatively bad impregnating characteristics. Specifically, when the density of the carbon material increases during roll-pressing or the like, the impregnating characteristics become very poor. One nonlimiting example of a suitable carbon material is graphite or the like.

Any material capable of generating pores can be used as the pore forming material. The pore forming material may be a thermally decomposable material, a material capable of dissolving in the electrolytic solution, or a mixture thereof. The thermally decomposable material may be ammonium carbonate, ammonium bicarbonate, ammonium oxalate or the like. The material capable of dissolving in the electrolytic solution may be a salt that is easily dissolved in a non-aqueous electrolyte, such as a lithium salt or the like. For example, the material capable of easily dissolving in the non-aqueous electrolyte can be LiClO₄, LiBF₄, LiPF₆, LiCF₃SO₃, or the like.

The amount of the pore forming material in the electrode ranges from about 0.1 to about 10% by weight based on the total weight of the electrode active material. When the amount of the pore forming material is greater than about 10% by weight, the electrode density decreases. When the amount of the pore forming material is less than about 0.1% by weight, controlled porosity is difficult to achieve.

The present invention will now be described in detail with reference to the following examples. These examples are provided for illustrative purposes only, and do not limit the scope of the present invention.

### Manufacturing Anode Electrodes

### EXAMPLE 1

150 ml of distilled water was added to a mixture of 97 g of graphite powder, 1.5 g of styrene butadiene rubber (SBR), and 1.5 g of carboxy methyl cellulose (CMC). The mixture was stirred for 30 minutes using a mechanical mixing device, thus forming a first slurry.

The first slurry was coated on a 10 μm thick Cu current collector to a thickness of about 100 μm and a loading lever of 8 mg/cm² using a doctor blade. The first slurry was then dried.

150 ml of distilled water was then added to a mixture of 5 g of ammonium bicarbonate, 97 g of graphite powder, 1.5 g of SBR, and 1.5 g of CMC and stirred using a mechanical mixing device for 30 minutes to produce a second slurry. The second slurry was coated on the first slurry to a loading level of about 2 mg/cm².

The resulting coated Cu current collector was roll-pressed to a density of 1.7 mg/cm³ and dried in a vacuum at 145° C. for 3 hours, thereby forming an anode plate.

### EXAMPLE 2

150 ml of distilled water was added to a mixture of 97 g of graphite powder, 1.5 g of SBR, and 1.5 g of CMC and stirred for 30 minutes using a mechanical mixing device, thereby forming a slurry.

The slurry was coated on a 10 μm thick Cu current collector to a loading level of 10 mg/cm² using a doctor blade. The slurry was then dried.

The coated Cu current collector was further coated by spraying it with ammonium bicarbonate dissolved in ethanol. The ammonium bicarbonate was coated to a loading level of about 0.1 mg/cm².

The coated Cu current collector was roll-pressed to a density of 1.7 g/cm³ and then dried in a vacuum at 145° C. for 3 hours, thereby forming an anode plate.

### EXAMPLE 3

An anode plate was manufactured as in Example 1 except that ammonium oxalate was used instead of ammonium bicarbonate.

### EXAMPLE 4

An anode plate was manufactured as in Example 2 except that ammonium oxalate was used instead of ammonium bicarbonate.

### EXAMPLE 5

An anode plate was manufactured as in Example 1 except that LiClO₄ was used instead of ammonium bicarbonate.

### EXAMPLE 6

An anode plate was manufactured as in Example 2 except that LiClO₄ was used instead of ammonium bicarbonate.

### EXAMPLE 7

An anode plate was manufactured as in Example 1 except that a mixture of ammonium oxalate and LiClO₄ was used instead of ammonium bicarbonate.

### EXAMPLE 8

An anode plate was manufactured as in Example 2 except that a mixture of ammonium oxalate and LiClO₄ was used instead of ammonium bicarbonate.

### EXAMPLE 9

An anode plate was manufactured as in Example 1 except that 10 g of ammonium bicarbonate was used.

### EXAMPLE 10

An anode plate was manufactured as in Example 1 except that 20 g of ammonium bicarbonate was used.

### EXAMPLE 11

An anode plate was manufactured as in Example 2 except that the ammonium bicarbonate was coated to a loading level of 0.2 mg/cm².

### EXAMPLE 12

An anode plate was manufactured as in Example 2 except that the ammonium bicarbonate was coated to a loading level of 0.4 mg/cm².

### COMPARATIVE EXAMPLE 1

An anode plate was manufactured as in Example 1 except that the pore forming material was not used.

### COMPARATIVE EXAMPLE 2

An anode plate was manufactured as in Example 2 except that the pore forming material was not used.

### Manufacturing of Half Cells

Each of the anode plates of Examples 1 to 12 and Comparative Examples 1 and 2 was cut to a size of 2×3 cm³. A half cell was manufactured using each anode plate, a lithium metal as a counter electrode, and an electrolyte formed by adding 2.3 wt % of vinylene carbonate (VC) to a solution of ethylene carbonate (EC), diethylcarbonate (DEC), fluorobenzene (FB), and dimethyl carbonate (DMC) in a weight ratio of 3:5:1:1.

### Charge and Discharge Test

Each half cell was discharged a constant current of 35 mA per 1 g of active material until 0.001 V was obtained with respect to the Li electrode. Thereafter, each half cell was discharged a constant voltage of 0.001 V until the current decreased to 3.5 mA per 1 g of the active material.

Each discharged cell was allowed to sit for about 30 minutes and then charged at a constant current of 35 mA per 1 g of the active material until the voltage reached 1.5 V.

Each cell was subjected to one discharge/charge cycle at 0.1 C, two discharge/charge cycles at 0.2 C, one discharge/charge cycle at 0.5 C, one discharge/charge cycle at 1 C, and one discharge/charge cycle at 2 C. High-rate charge/discharge characteristics were measured using a ratio of high rate charge capacity to the second 0.2 C cycle charge capacity. The results are shown in Table 1.

TABLE 1

| | 0.2 C | 0.2 C | 0.5 C | 1 C | 2 C |
|---|---|---|---|---|---|
| | Discharge/ | Discharge/ | Discharge/ | Discharge/ | Discharge/ |
| | Charge | Charge | Charge | Charge | Charge |
| | Capacity | Capacity | Capacity | Capacity | Capacity |
| | (mAh) | (mAh) | (mAh) | (mAh) | (mAh) |
| Example 1 | 23.98/20.86 | 20.83/20.44 | 20.47/20.29 | 20.00/19.93 | 19.63/18.53 |
| High-rate | — | 100% | 99.3% | 97.5% | 90.7% |
| charge/discharge | | | | | |
| characteristics | | | | | |
| Example 2 | 24.17/20.96 | 20.92/20.50 | 20.57/20.39 | 20.18/20.07 | 20.03/18.71 |
| High-rate | — | 100% | 99.5% | 97.9% | 91.3% |
| charge/discharge | | | | | |
| characteristics | | | | | |
| Example 3 | 23.64/20.87 | 20.73/20.38 | 20.38/20.24 | 20.00/19.82 | 19.54/18.46 |
| High-rate | — | 100% | 99.3% | 97.3% | 90.6% |
| charge/discharge | | | | | |
| characteristics | | | | | |
| Example 4 | 24.02/20.87 | 20.84/20.40 | 20.49/20.24 | 20.03/19.89 | 19.86/18.53 |
| High-rate | — | 100% | 99.2% | 97.5% | 90.8% |
| charge/discharge | | | | | |
| characteristics | | | | | |
| Example 5 | 23.64/21.08 | 20.91/20.52 | 20.38/20.31 | 20.00/19.86 | 19.51/18.33 |
| High-rate | — | 100% | 99.0% | 96.8% | 89.3% |
| charge/discharge | | | | | |
| characteristics | | | | | |
| Example 6 | 23.55/21.12 | 20.77/20.40 | 20.24/20.10 | 19.96/19.65 | 19.37/18.14 |
| High-rate | — | 100% | 98.5% | 96.3% | 88.9% |
| charge/discharge | | | | | |
| characteristics | | | | | |
| Example 7 | 23.98/20.98 | 20.83/20.56 | 20.47/20.35 | 20.07/20.03 | 19.63/18.84 |
| High-rate | — | 100% | 99.0% | 97.4% | 91.6% |
| charge/discharge | | | | | |
| characteristics | | | | | |
| Example 8 | 23.92/20.94 | 20.92/20.63 | 20.57/20.39 | 20.28/20.10 | 20.07/19.00 |
| High-rate | — | 100% | 98.8% | 97.4% | 92.1% |
| charge/discharge | | | | | |
| characteristics | | | | | |
| Example 9 | 23.97/20.77 | 20.80/20.38 | 20.38/20.24 | 19.96/19.80 | 19.47/18.35 |
| High-rate | — | 100% | 99.3% | 97.2% | 90.0% |
| charge/discharge | | | | | |
| characteristics | | | | | |
| Example 10 | 24.23/20.87 | 20.70/20.35 | 20.32/20.20 | 20.18/19.96 | 19.82/18.33 |
| High-rate | — | 100% | 99.3% | 98.1% | 90.2% |
| charge/discharge | | | | | |
| characteristics | | | | | |
| Example 11 | 24.30/20.52 | 20.70/20.52 | 20.38/20.17 | 19.96/19.12 | 19.40/17.54 |
| High-rate | — | 100% | 98.3% | 93.2% | 85.5% |
| charge/discharge | | | | | |
| characteristics | | | | | |
| Example 12 | 24.06/20.45 | 20.56/20.40 | 20.31/20.17 | 19.96/19.68 | 19.26/17.75 |
| High-rate | — | 100% | 98.9% | 96.5% | 87.0% |
| charge/discharge | | | | | |
| characteristics | | | | | |
| Comparative | 22.91/19.76 | 20.30/20.03 | 20.12/19.67 | 18.00/17.96 | 16.57/13.91 |
| Example 1 | | | | | |
| High-rate | — | 100% | 98.2% | 89.7% | 69.4% |
| charge/discharge | | | | | |
| characteristics | | | | | |
| Comparative | 22.42/19.25 | 20.42/20.16 | 20.21/20.04 | 18.13/17.93 | 16.70/14.23 |
| Example 2 | | | | | |
| High-rate | — | 100% | 99.4% | 88.9% | 70.6% |
| charge/discharge | | | | | |
| characteristics | | | | | |

As shown in Table 1, the charge capacities of the half cells including the anode plates according to Examples 1 through 12 did not decrease substantially. Rather, they maintained 85% or more of their charge/discharge capabilities when charged and discharged at high rates. This is 20% or greater than the half cells including the anode plates according to Comparative Examples 1 and 2. These excellent charge/discharge characteristics can be explained as follows. The porosity of the electrode active material was controlled using a pore forming material in Examples 1 through 12 such that the contact area between the electrode active material and the electrolytic solution was larger than that in Comparative Examples 1 and 2. As a result, the impregnating characteristics of the electrolytic solution were improved, the electrolytic solution could smoothly penetrate into the inner portion of the electrode, and the area of the electrode in contact with the electrolytic solution was increased, enabling ions to move more smoothly. Due to these excellent high-rate charge/discharge characteristics, the cells have large capacities, thus preventing decreases in performance.

An electrode for an electrochemical cell according to the present invention includes an electrode active material with controlled porosity. In particular, after the electrode is roll-pressed, the porosity of the surface of the electrode is equal to or greater than the porosity of the inner portion of the electrode. Therefore, the impregnating characteristics of the electrolytic solution are improved and the capacitance of the electrode, which occurs when charged and discharged at high rates does not significantly decrease, thereby improving the charge and discharge characteristics. Cells including the electrodes exhibit excellent charge and discharge characteristics.

While the present invention has been described with reference to certain exemplary embodiments, it will be understood by those of ordinary skill in the art that various changes in form and details may be made without departing from the spirit and scope of the present invention as defined by the following claims.

What is claimed is:

1. A method of manufacturing an electrode for an electrochemical cell, the method comprising:
coating a current collector with an electrode active material;
coating the electrode active material with a mixture of a pore forming material and the electrode active material to form an electrode;
roll-pressing the electrode; and
sintering the roll-pressed electrode.

2. A method of manufacturing an electrode for an electrochemical cell, the method comprising:
coating a current collector with an electrode active material;
coating the electrode active material with a pore forming material to form an electrode;
roll-pressing the electrode; and
sintering the roll-pressed electrode.

3. The method of claim 1, wherein the pore forming material is selected from the group consisting of thermally decomposable materials, materials capable of dissolving in an electrolytic solution and mixtures thereof.

4. The method of claim 3, wherein the thermally decomposable material comprises a compound selected from the group consisting of ammonium carbonate, ammonium bicarbonate, ammonium oxalate and mixtures thereof.

5. The method of claim 3, wherein the material capable of dissolving in the electrolytic solution comprises a compound selected from the group consisting of LiClO₄, LiBF₄, LiPF₆, LiCF₃SO₃, and mixtures thereof.

6. The method of claim 1, wherein the pore forming material is present in the electrode in an amount ranging from about 0.1 to about 10% by weight based on the total amount of the electrode active material.

7. The method of claim 2, wherein the pore forming material is selected from the group consisting of thermally decomposable materials, materials capable of dissolving in an electrolytic solution and mixtures thereof.

8. The method of claim 7, wherein the thermally decomposable material comprises a compound selected from the group consisting of ammonium carbonate, ammonium bicarbonate, ammonium oxalate and mixtures thereof.

9. The method of claim 7, wherein the material capable of dissolving in the electrolytic solution comprises a compound selected from the group consisting of LiClO₄, LiBF₄, LiPF₆, LiCF₃SO₃, and mixtures thereof.

10. The method of claim 2, wherein the pore forming material is present in the electrode in an amount ranging from about 0.1 to about 10% by weight based on the total weight of the electrode active material.
